(19) United States
(12) Patent Application Publication
(10) Pub. No.: US 2009/0152849 A1
(43) Pub. Date: Jun. 18, 2009

(54) SIDE IMPACT BOLSTER

(76) Inventors: Bijoy K. Saraf, Troy, MI (US); Michael N. Trutzel, Orion, MI (US); Kalu Uduma, Detroit, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 12/333,765

(22) Filed: Dec. 12, 2008

Related U.S. Application Data
(60) Provisional application No. 61/013,503, filed on Dec. 13, 2007.

(51) Int. Cl. B60R 21/21

(52) U.S. Cl. 280/730.2

(57) ABSTRACT

An energy-management device is provided for occupant protection in side-impact events and is designed to meet FMVSS214 and IIHS barrier tests. The energy-management device is designed to be part of a side door trim panel of a vehicle and forms the “A-surface” around a first area where the shoulder/thorax of an occupant would be located and around a second area where a pelvis of an occupant would be located when seated in a vehicle seat of the vehicle. The energy-management device may be constructed out of a blow-molded compounded material such as, for example, Thermoplastic Polyolefin plastic (TPO).

### CROSS-REFERENCE TO RELATED APPLICATION

This application claims the benefit of U.S. Provisional Patent Application Ser. No. 61/013,503 filed Dec. 13, 2007.

### FIELD OF THE INVENTION

The present invention relates to energy management systems and more particularly to an energy management system for a side-impact event.

### BACKGROUND AND SUMMARY OF THE INVENTION

Energy management systems for automotive side-impact events typically include airbags mounted on one or both of a seat back or an inside surface of a side-door panel. The airbag is designed to cushion a thorax region of an occupant during an impact event (IE). Variations of the seat-back mounted airbag exist that either extend up to protect the head of an occupant—known as the head/thorax airbag—or extend down to protect the pelvis; known as the pelvis-thorax airbag. The above variations in energy management system design increase the airbag volume, which typically results in an increase in inflator output.

The National Highway Traffic Safety Administration (NHTSA) has recently finalized the requirements of Federal Motor Vehicle Safety Standard 214 (FMVSS214), which now includes the fifth percentile anthropomorphic test device (ATD) as well as a pole-impact test event. The Insurance Institute of Highway Safety (IIHS) has also upgraded side impact test requirements to more closely address crash events between passenger vehicles and larger vehicles such as, for example, trucks and sport utility vehicles. The active side bolster (ASB) of the present invention address the new FMVSS214 standard as well as the new IIHS test requirements.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an active side bolster (ASB) in accordance with the principles of the present invention shown with one inflator;

FIG. 2 is a perspective view of an ASB in accordance with the principles of the present invention shown with two inflators;

FIG. 3 is a partial perspective view of a door panel incorporating an ASB in accordance with the principles of the present invention; and

FIG. 4 is a schematic representation of a door illustrating coverage regions of the ASB of FIGS. 1-3 on an anthropomorphic test device (ATD).

### DETAILED DESCRIPTION OF THE PREFERRED EMBODIMENTS

The following description of the preferred embodiment(s) is merely exemplary in nature and is in no way intended to limit the invention, its application, or uses.

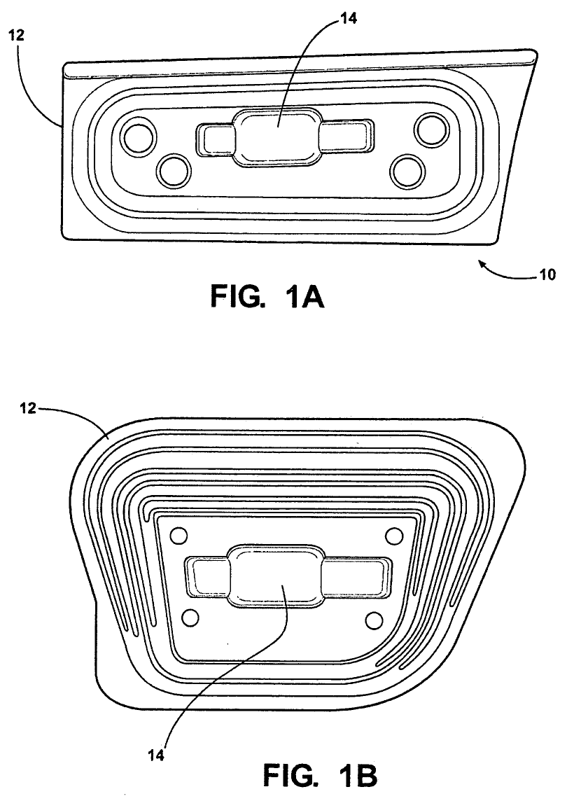

The energy-management device of FIGS. 1-4 is directed to occupant protection during side-impact events and is designed to meet FMVSS214 and the IIHS barrier tests. The energy-management device is designed to be part of a side door trim panel of a vehicle and forms the “A-surface” around a first area where the shoulder/thorax of an occupant would be located and around a second area where a pelvis of an occupant would be located when seated in a vehicle seat of the vehicle.

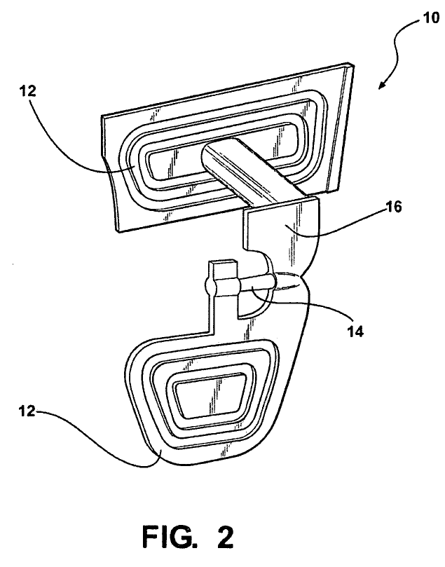

The energy-management device may be constructed as two chambers connected by a conduit, whereby a single inflator may communicate with each chamber via the common conduit (FIG. 2). Alternatively, the energy-management device may include two independent and discrete chambers with each chamber having a dedicated inflator (FIG. 1). The chambers may be formed out of a blow-molded compounded material such as, for example, Thermoplastic Polyolefin plastic (TPO) that can withstand the requirements of an automotive airbag.

The device may be attached to a door inner panel and may deploy toward an occupant when initiated by a side impact sensor system (i.e., during an impact event, for example). Deployment of the bag is through unfolding of a series of corrugations (ribs) designed in a B-surface thereof and the deployment direction, shape, and depth (volume) of the device is dictated by the bag attachments (FIG. 1, for example) to the door inner panel, the rib pattern, the overall number of ribs, and the depth profile of the ribs and device. This energy management or occupant protection device will hereinafter be referred to as the Active Side Bolster (ASB).

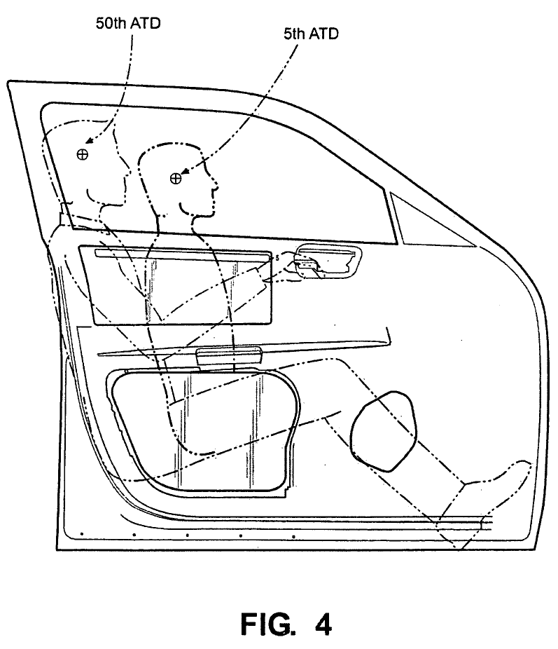

With reference to FIGS. 1-4, the ASB 10 is shown to include two independent inflatable blow molded plastic chambers 12; one for the shoulder/thorax area and the other for the pelvis area (FIG. 4). The two chambers 12 can either be inflated by a single inflator 14 attached to a tube 16 connecting the chambers 12 or, alternatively, can be inflated by two individual inflators 14. A system having two inflators 14 may allow for design simplicity, as the connecting tube 16 disposed between the two chambers 12 is obviated. Furthermore, with two separate inflators 14, each chamber 12 may be “tuned” by allowing for adjustment of bag stiffness (by controlling the size of a vent hole and/or the mass-flow rate into each chamber 12, for example) as well as the deployment time of each bag 12. Also, because each inflator 14 may be positioned in closer proximity to each chamber 12, the deployment of each 12 bag may be faster when compared to a single-inflator design.

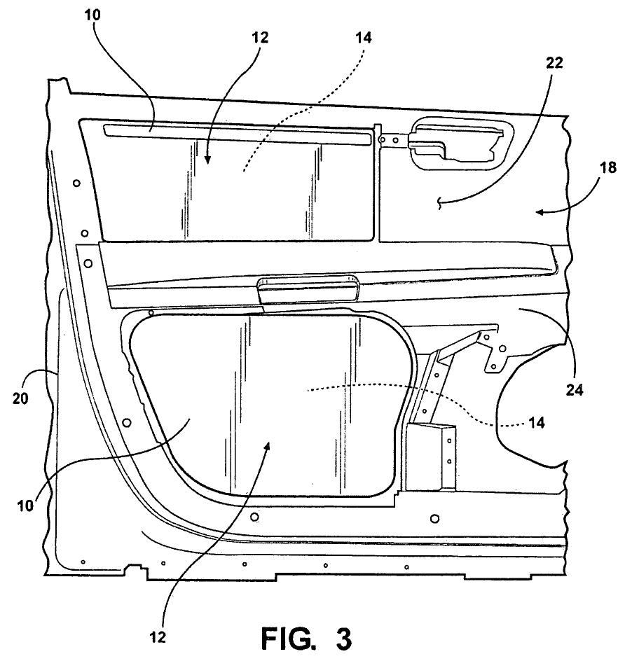

FIGS. 3 and 4 show the integration of the ASB 10 into a door 18 of a vehicle 20. Because the ASB 10 is dependent on the A-surface 22 of the door trim 24, the ASB 10 is unique for the particular door 18. Therefore, if the design of the door trim changes, the design of the ASB 10 will similarly change. As shown, the ASB 10 provides coverage for the fifth percentile ATD and fiftieth percentile ATD in the FMVSS214 test configuration and provides coverage for the fifth percentile ATD in the IIHS test mode.

The ASB 10 may be inflated by a hybrid or a pyrotechnic inflator 14. A low-powered inflator may be selected with each chamber 12 having a separate inflator 14. Therefore, the orientation, shape and depth of each ASB 12 can be tuned to the individual coverage and stiffness requirements of each location on the door 18.

The description of the invention is merely exemplary in nature and, thus, variations that do not depart from the gist of the invention are intended to be within the scope-of the invention. Such variations are not to be regarded as a departure from the spirit and scope of the invention.

What is claimed is:

1. A vehicular side impact bolster comprising:
an inflatable plastic chamber having an outer surface comprising a rigid interior trim panel for a side door of a vehicle adapted to be positioned at a preselected location on the side door.

2. The bolster of claim 1 wherein the inflatable plastic chamber includes a rib or corrugation on an interior surface thereof and the plastic chamber is adapted to inflate by unfolding the rib or corrugation.

3. The bolster of claim 1 wherein the chamber comprises a blow molded material.

4. The bolster of claim 3 wherein the blow molded material comprises thermoplastic polyolefin plastic.

5. An energy management system for a vehicular side impact event comprising:
a first inflatable plastic chamber having a first outer surface comprising a first rigid interior trim panel for a side door of a vehicle positioned so as to be adjacent to a shoulder area of an occupant seated adjacent the side door; and
a second inflatable plastic chamber having a second outer surface comprising a second rigid interior trim panel for the side door positioned so as to be adjacent a pelvic area of the occupant.

6. The energy management system of claim 5 further comprising an inflator coupled for fluid communication with the first and second chambers.

7. The energy management system of claim 5 further comprising a first inflator coupled for fluid communication with the first chamber and, a second inflator coupled for fluid communication with the second chamber.

8. The energy management system of claim 5 wherein the first and second chambers respectively include first and second ribs or corrugations on respective first and second interior surfaces of the first and second chambers and the first and second chambers are adapted to inflate by unfolding the ribs or corrugations.

9. The energy management system of claim 5 wherein the first and second chambers comprise blow molded material.

10. The energy management system of claim 9 wherein the blow molded material comprises thermoplastic polyolefin plastic.
